(19) United States
(12) Patent Application Publication
(10) Pub. No.: US 2003/0182106 A1
(43) Pub. Date: Sep. 25, 2003

(54) Method and device for changing the temporal length and/or the tone pitch of a discrete audio signal

(75) Inventors: Jorg Bitzer, Bremen (DE); Mira Meemken, Bremen (DE)

Correspondence Address: ALTERA LAW GROUP, LLC, 6500 CITY WEST PARKWAY, SUITE 100, MINNEAPOLIS, MN, 55344-7704, US

(73) Assignee: Spectral Design, Bremen (DE)

(21) Appl. No.: 10/388,133

(22) Filed: Mar. 13, 2003

(30) Foreign Application Priority Data
Mar. 13, 2002 (DE) 102 10 978.8-53
Jan. 21, 2003 (DE) 103 02 448.4

(51) Int. Cl. G10L 19/12; G10L 11/04

(52) U.S. Cl. 704/207; 704/221

(57) ABSTRACT

The invention relates to a method and a device for changing the temporal length and/or the tone pitch of a discrete audio signal. For improving the sound quality in such a method, according to the invention it is proposed that the audio signal be split into at least two partial signals and, in each case, fed to a processing channel; that the temporal length and/or the tone pitch of the partial signals be changed separately in different ways; and that the separately-processed partial signals then be combined into an output signal. Alternatively, according to the invention it is proposed that the audio signal be fed to at least two parallel processing channel, that the temporal length and/or the tone pitch of the audio signals be changed separately in different ways, that the separately-processed audio signals be split into two partial signals in each case, and that an output signal then be formed through combination of, in each case, at least one partial signal of each processing channel.

The invention relates to a method and a device for changing the temporal length and/or the tone pitch of a discrete audio signal. In addition, the invention relates to a computer program for implementation of the method and a data carrier with such a program.

In the processing of audio signals, it can be necessary, for example in the music production process, to change or distort already-recorded voices and/or instruments without having to carry out a new recording. Examples of this can be a modification of the tempo of a musical piece or a subsequent changing of the pitch. In addition, new, creative possibilities of forming music are brought about.

Known methods for temporal variation, especially for lengthening audio signals, and for changing the pitch of audio signals are described, for example, in “Time and Pitch Scale Modification of Audio Signals” by Jean Loroche in M. Kahrs and Karlheinz Brandenburg (editors), Applications of Digital Signal Processing to Audio and Acoustics, Kluwer Academic Press, 1998, Chapter 7, pp. 279-310.

The known methods for temporal variation can be divided into two basic techniques. First, there are solutions in the time domain. A prerequisite for these algorithms is the assumption that the signal to be modified is monophonic, thus not a mixture of several instruments. Examples of such solutions are the pitch synchronous splicing (PSS) and pitch synchronous overlap add (PSOLA) methods.

In the PSS process the changing of the signal length is based on a temporal repetition of short segments, a repetition in the raster of the fundamental frequency being considered especially advantageous. In the PSOLA method, in addition a windowing takes place before the new signal segments are added to the output signal. The signal segments to be added are again windowed repetitions of the input signal at the interval of the fundamental frequency. In addition, a determination of the fundamental frequency is necessary, for which purpose many known algorithms are available.

The introduction of long-time correlation through the repetition of fixed signal segments has proved to be a particular disadvantage of the PSOLA method. Through the repetition, the output signal acquires an unnatural tone that produces an unacceptable quality especially in the case of singing voices.

Second, solutions in the frequency domain are known. They utilize the well-known Fourier's theorem, which allows any complex signal to be represented as a decomposition of sinusoidal oscillations. With this method, mixtures of several signals, e.g. instruments, can also be temporally varied.

In the frequency-domain method, the so-call phase vocoder has proved to be especially advantageous. In this method the short-time spectra present in the frequency domain are mapped onto a new, fixed raster that corresponds to the factor of the temporal change. For example, in a doubling of the tone length between the short-time absolute-value spectra, new, estimated spectra are introduced. The calculation of the new spectra takes place by mean of appropriate interpolation methods.

In the frequency-domain methods, it has proven disadvantageous that through the interpolation in the frequency domain, pulses in the time domain are distinctly lengthened and, due to this, pulse signals gain too much smoothness.

For the changing the tone pitch, until now two basic methods have been known. In the first method, the signal to be changed is lengthened or shortened by a particular factor in order to then, by means of a changed readout rate, i.e. a so-called resampling, obtain a signal whose tone pitch has been changed. For example, for a variation of the tone pitch by an octave (doubled frequency) a lengthening of the signal by a factor of two is necessary. If, now, only every second sampling value is read out and the signal has been previously low-pass filtered in order to avoid aliasing, then a signal of the doubled frequency is obtained. However, in the application of this method it has become evident that the natural resonance behavior of an instrument (the formants) is likewise shifted. The new output signal has an especially unnatural sound. In the case of speech, this is expressed by the so-called Mickey Mouse effect.

The second method for changing the tone pitch avoids this problem by selecting a process derived from the PSOLA method and known as Lent's algorithm after its inventor, which process is described in “An Efficient Method for Pitch Shifting Digitally Sampled Sounds”, K. Lent, Computer Music Journal, 13 (4): 65-71, 1989. In this, in order to form the new output signal an overlapping of the partial segments in the raster of the desired new fundamental frequency is carried out. The formant behavior remains constant, but the fundamental frequency can be thus changed. However, in the case of natural signals, in particular a singing voice, the formants change slightly. For this reason, the combination of the Lent's algorithm with a subsequent resampling, which effects only a very slight shifting, has proven to be especially advantageous.

It is common to all of the known methods that only one rule for computing is used for the tone pitch transformation in the upward or downward directions, and that the input signal is changed in a broadband manner and as a whole. In addition, in all of the known methods more or less undesired side effects occur, which it is worthwhile to minimize. Decisive for the excellence of the method is always the subjectively perceived quality of the output signal after the changing.

U.S. Pat. No. 5,952,596 describes a method for changing the speed and the tone pitch of audio signals by means of digital signal processing. Known from U.S. 2001/0023399 A1 are an audio-signal processing device and a corresponding method, by means of which an audio signal compressed or expanded in the time domain can be reproduced without a change in the tone pitch.

In the dissertation “Modèles et modification du signal sonore adaptès à ses caractèristiques locales” (“Patterns and Modification of the Sound Signal adapted to its local Characteristics”) by Geoffroy Peeters, presented on Jul. 11, 2001 at the l'lRCAM, Center Pompidou, Paris, a method is suggested that is based on the combination of the known PSOLA method with the description and modification of a signal using a sinusoidal model (SINOLA sinusoidal overlap-add). In this process, the sinusoidal model is first determined from the input signal, and subsequently the input signal is estimated from the obtained model parameters. Through subtraction of the estimated input signal from the actual input signal arises a residual signal, which can be modified by means of PSOLA in tone pitch and tone length. Next, the model parameters are changed according to the new tone pitch and tone length and, with the aid of the sinusoidal model, an output signal is synthesized. To this output signal is then added the modified residual signal in order to obtain the final output signal.

In this process, it is assumed that the input signal can be well-described through a sinusoidal model. As soon as this is not the case, the estimation of the model parameters become imprecise or even false, which can lead to a loss of quality. Moreover, a model estimation is very calculation-intensive. Thus, in the development of the invention attention was paid to the fact that the processing of the signal can take place irrespective of the signal type.

The invention is therefore based on the task of specifying a method and a device for changing the temporal length and/or the tone pitch of a discrete audio signal, by means of which an improved sound quality can be achieved and the processing of the audio signal can take place irrespective of the signal type.

According to the invention, this task is accomplished through a method according to claim 1, which comprises the following steps:

splitting of the audio signal into at least two partial signals

feeding of the partial signals to a processing channel in each case

separate changing of the temporal length and/or the tone pitch of the partial signals in different ways

combining of the separately processed partial signals to form an output signal

According to the invention, this task is accomplished also through the method according to claim 2, which comprises the following steps:

feeding of the audio signal to at least two parallel processing channels

separate changing of the temporal length and/or the tone pitch of the audio signals in the processing channels in different ways

splitting of the separately processed audio signals into at least two partial signals in each case

formation of an output signal through combination of at least one partial signal in each case of each processing channel

Appropriate devices according to the invention are specified in claims 23 and 24. A computer program for implementing the method according to the invention is specified in claim 25. A data carrier with such a computer program is specified in claim 26. Advantageous configurations of the invention are specified in the dependent claims.

Through the invention, the subjectively perceived quality of the output signal can be significantly improved. The decisive advantage relative to the known methods is the fact that a splitting of the audio signal into partial signals takes place, and that differently optimized processing methods are applied to the split, partial signals in order to change the tone length and/or the tone pitch. The splitting of the audio signals can here take place either before or after the different processing in the separated processing channels. However, it is crucial that, after the splitting, certain partial signals be combined again to form a single output signal. With respect to the changing of the length as well as the tone pitch, a significantly improved sound is achieved through the splitting and different processing. The invention thus makes possible, in the context of a temporal changing of the audio signal (time-scale) as well as in the context of tone pitch changing (pitch-scale/pitch-shift), an increase in the quality of the output signal, in comparison to the methods known until now.

According to a preferred form of the invention, the separate processing in the at least two parallel processing channels takes place by means of the same method with different parameters. Alternatively, completely different methods can also be used.

Preferred forms of the methods according to the invention for changing the tone length are specified in claims 4 through 9. A preferred form of the method according to the invention for changing the tone pitch of an audio signal is specified in claim 10.

In claims 6 and 7, two embodiment forms of the invention that reduce the calculation time are specified. In these, the new signal portions are combined by means of addition before the introduction into the audio signal and are only subsequently introduced in common into the audio signal through the PSOLA process. This has the advantage that the PSOLA process need be carried out only once.

A splitting of the audio signal through frequency splitting into individual frequency bands has proved to be especially advantageous. Here, preferably linear-phase and/or purely transversal filters are used for the splitting. In principle, however, a completely different manner of splitting the audio signal into individual partial signals is conceivable, for example a temporal splitting.

For the preferred frequency splitting, fundamentally different possibilities exist. Thus it is possible to undertake the frequency splitting into several partial signals through arbitrary allocation of the frequencies to the individual partial signals, in which case the possibility that one of the partial signals will correspond to the original signal should also be included. In addition, the frequency splitting can also take place in a complementary manner, so that the frequency range is split up into several non-overlapping partial ranges. Preferable here is complementary band splitting, in which the frequency range is subdivided into individual and in each case coherent frequency ranges, which are in each case associated with a partial signal.

A further preferred manner of frequency splitting involves a temporally variable band splitting. In this, the bandwidth of the partial signals is controlled by the current fundamental frequency.

According to a further aspect of the invention, the changing of the tone pitch and/or of the temporal length takes place in at least one processing channel by means of a formant-preserving process and in at least one other processing channel by means of a non-formant-preserving algorithm. This has the advantage that the artifacts that appear with non-formant-preserving algorithms are restricted to the frequency ranges in which these algorithms are applied. This is advantageous above all in the case of tone pitch changes in the downward direction, since here the use of formant-preserving algorithms leads to a very thin signal.

According to the invention, the processing channels operate strictly independently of one another, so that no information of any kind concerning the type of the processing (e.g. block length of the process) is known. This can lead to a quality loss at transients. A further improvement of the sound quality can thus be achieved by an additional aspect, according to which the separate processing of the at least two partial signals is synchronized, at least temporarily.

Through the synchronization, the subjectively perceived quality of the output signal can be improved still further. The decisive advantage of this aspect is that the individual processing channels no longer operate completely independently of one another, but rather are synchronized at least temporarily. Thus, during the processing influence can be exerted on the parameters of the process, so that, for example, a blurring of the transients can be prevented.

According to a preferred form of the above-mentioned aspect of synchronization, the synchronization of the processing channels takes place through a synchronization unit that handles control signals for the synchronization. These control signals comprise signals of the processing channel, for example the actual factor of the temporal lengthening of the audio signal (time stretch factor), the current block length, the current processing status (e.g. time point in the original signal), and signals for management, for example the aimed-at factor of the temporal lengthening of the audio signal (time stretch factor) or the synchronization time point that must be kept to by the processing channel.

Preferably, the synchronization of the separate processing takes place at transients in the audio signal, whereby the transients are preferably not changed. In principle, however, the synchronization is possible at any arbitrary time point, e.g. at the time of synchronization with a video image associated with the audio signal. In addition, through, for example, the influencing of the processing parameters of the respective algorithm (e.g. the block length or the time stretch factor), synchronization (only) at specific time points can be achieved.

According to an advantageous development of the invention, after the processing of the partial signals a delaying of the partial signals is effected by means of delay elements. This is advantageous because, due to the processing of the partial signals using different methods, different propagation times and/or phase positions can arise. These can therefore be equalized in order to obtain a high-quality output signal.

According to a further preferred form, the changing of the tone pitch and/or the length of the discrete audio signal takes place at a constant scan rate. This has the advantage that the formants of the input signal are not altered. However, it is also possible to slightly vary the scan rate for the processing.

In the following, the invention shall be explained in detail with the aid of the embodiment examples illustrated in the drawings. These show:

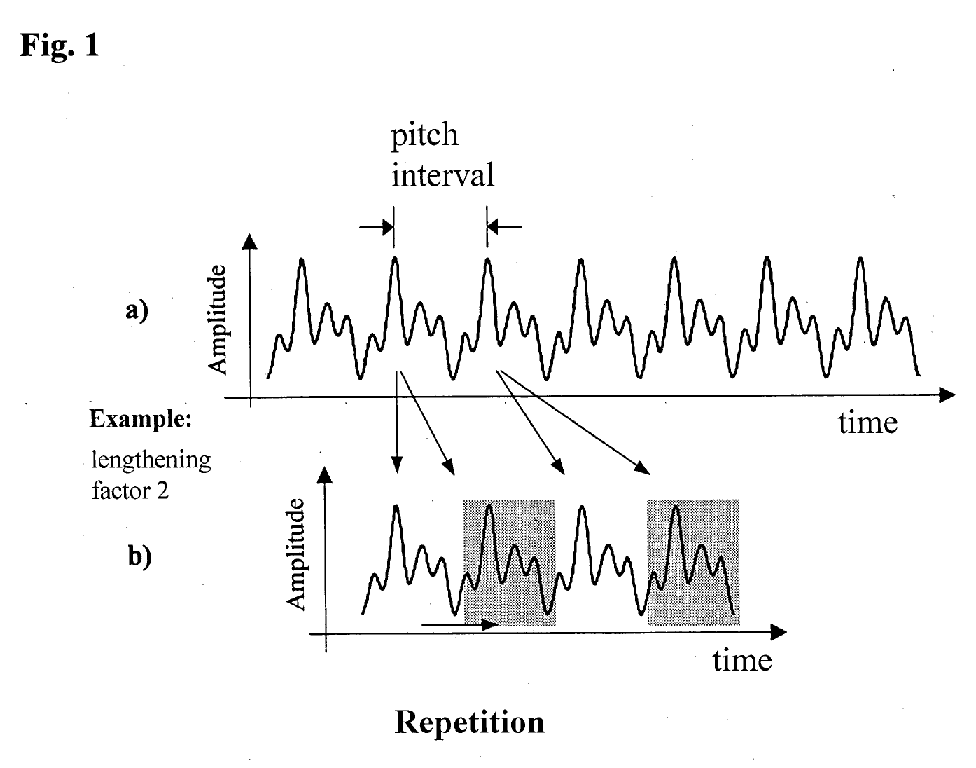

FIG. 1: an example for changing the length of an audio signal through the so-called pitch synchronous splicing process

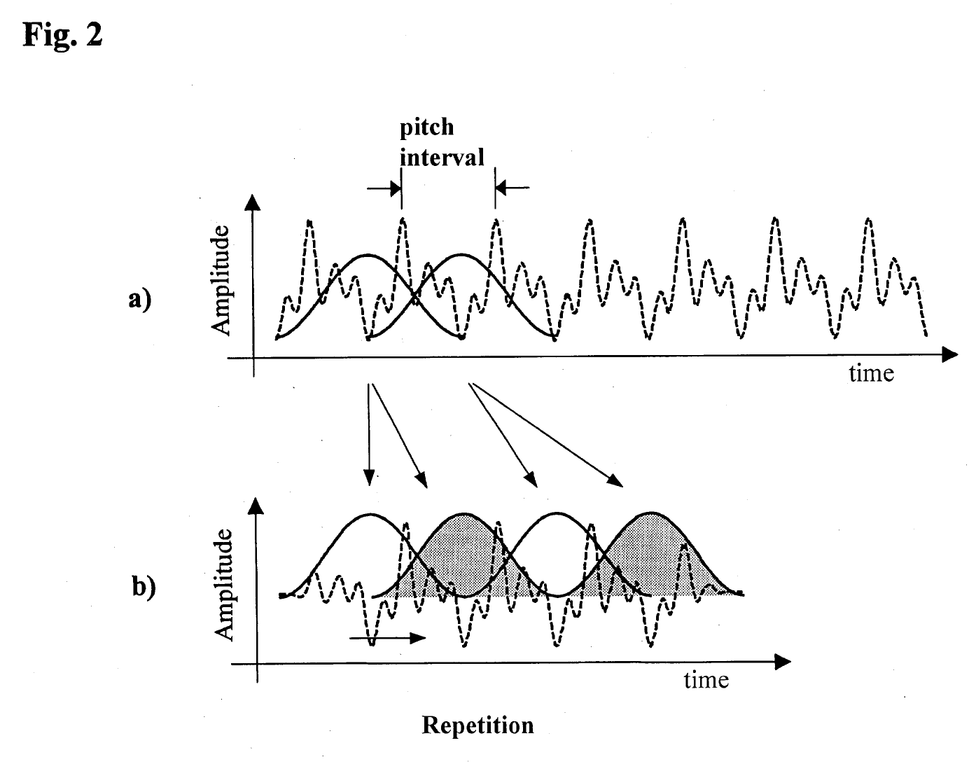

FIG. 2: an example for changing the length of an audio signal through the so-called pitch synchronous overlap-add (PSOLA) process

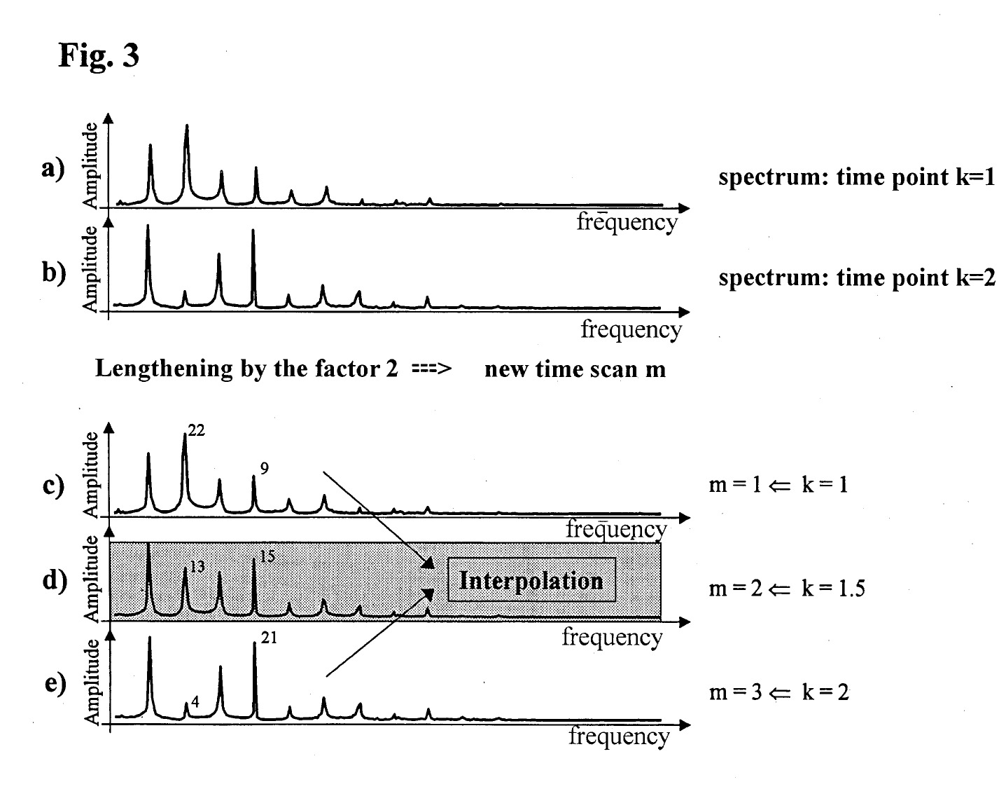

FIG. 3: the schematic manner of operation of the phase vocoder for changing the length of an audio signal

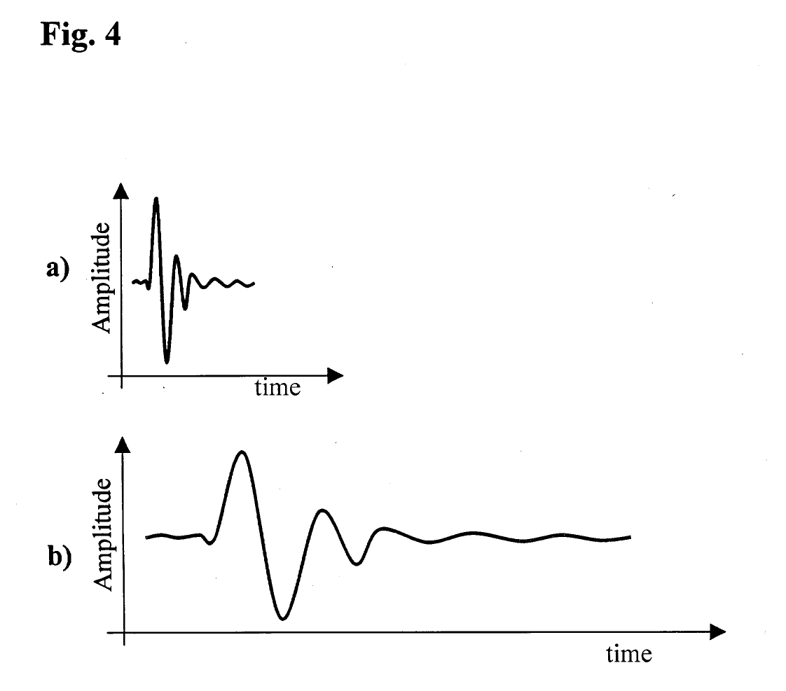

FIG. 4: the changing of a pulse through the phase vocoder

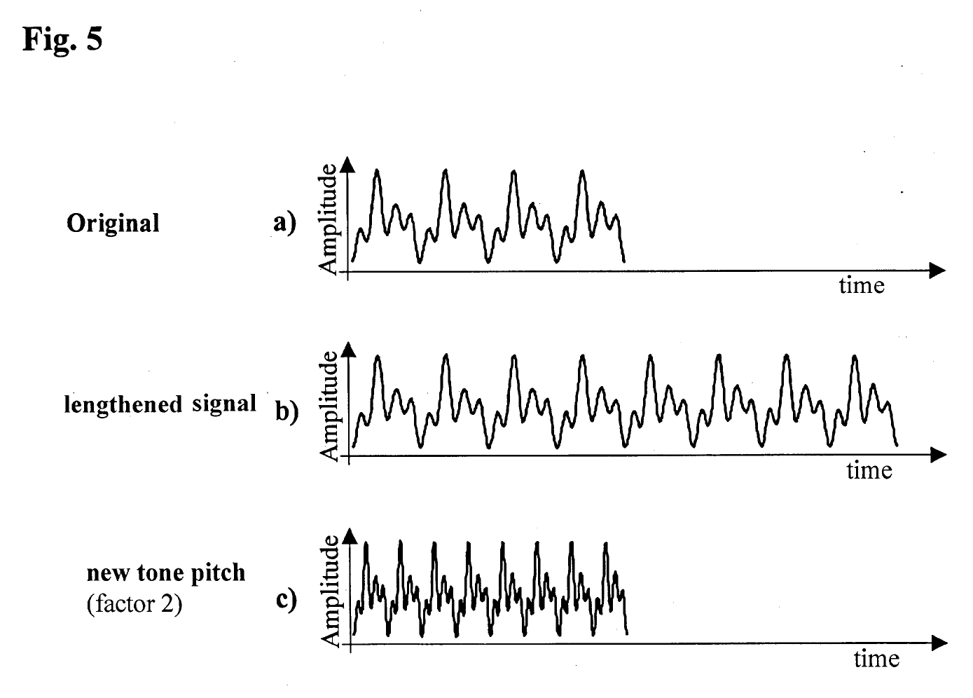

FIG. 5: schematically, the manner of operation of the resampling in order to change the tone pitch

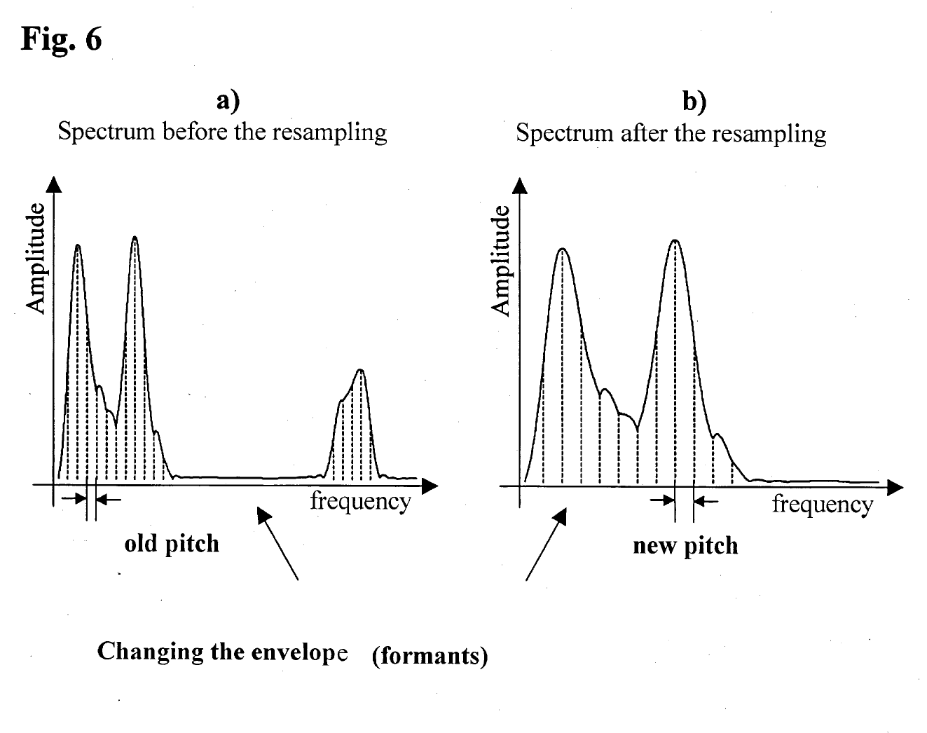

FIG. 6: schematically, the problems involved in changing the tone pitch using a resampling method

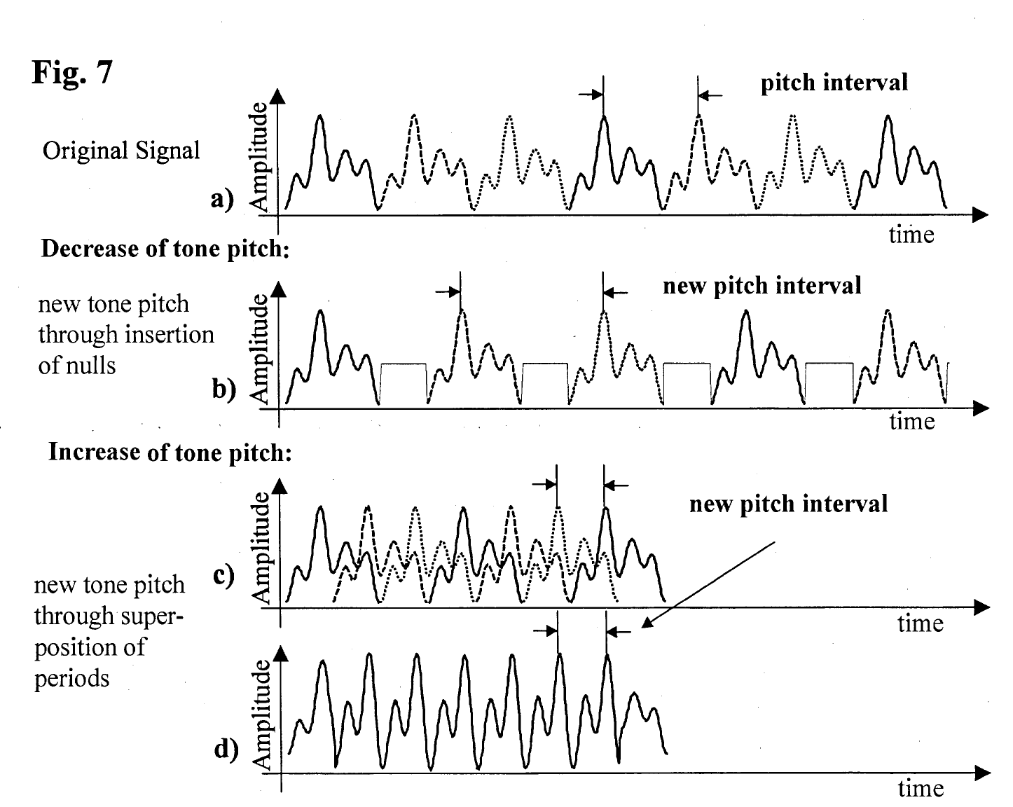

FIG. 7: schematically, the manner of operation of Lent's algorithm for changing the tone pitch

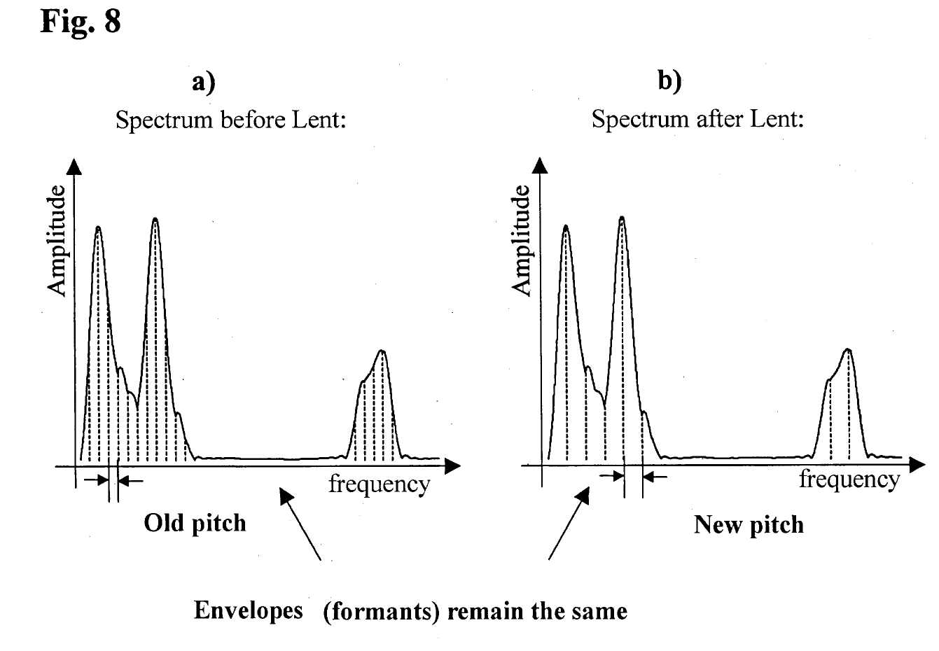

FIG. 8: schematically, the formant behavior of Lent's algorithm in a tone pitch changing

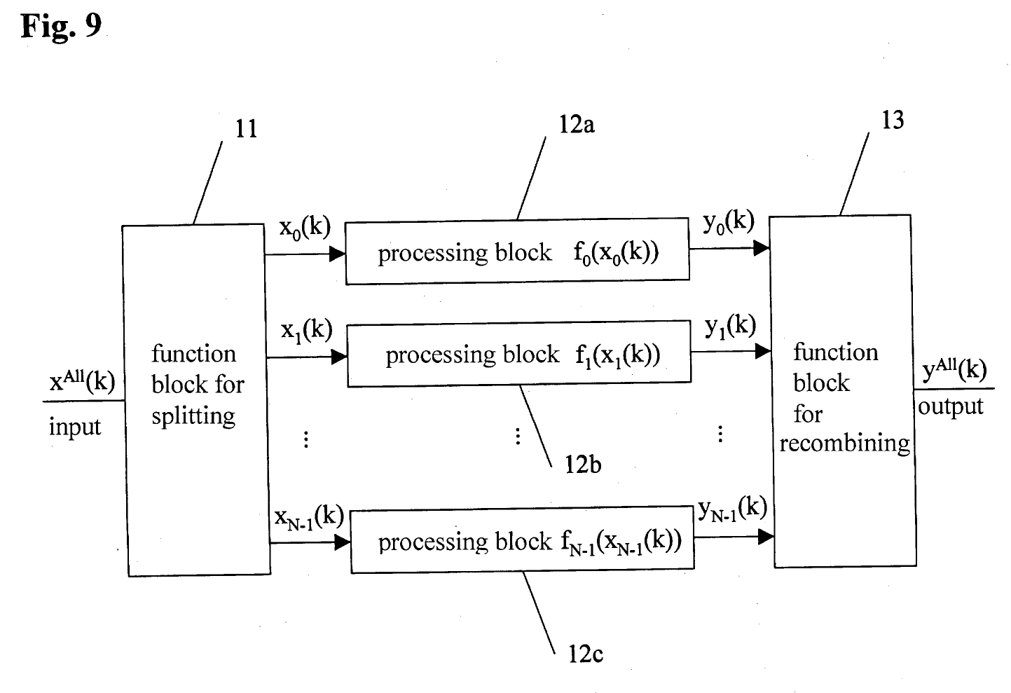

FIG. 9: a block diagram of a first general embodiment form of the method according to the invention

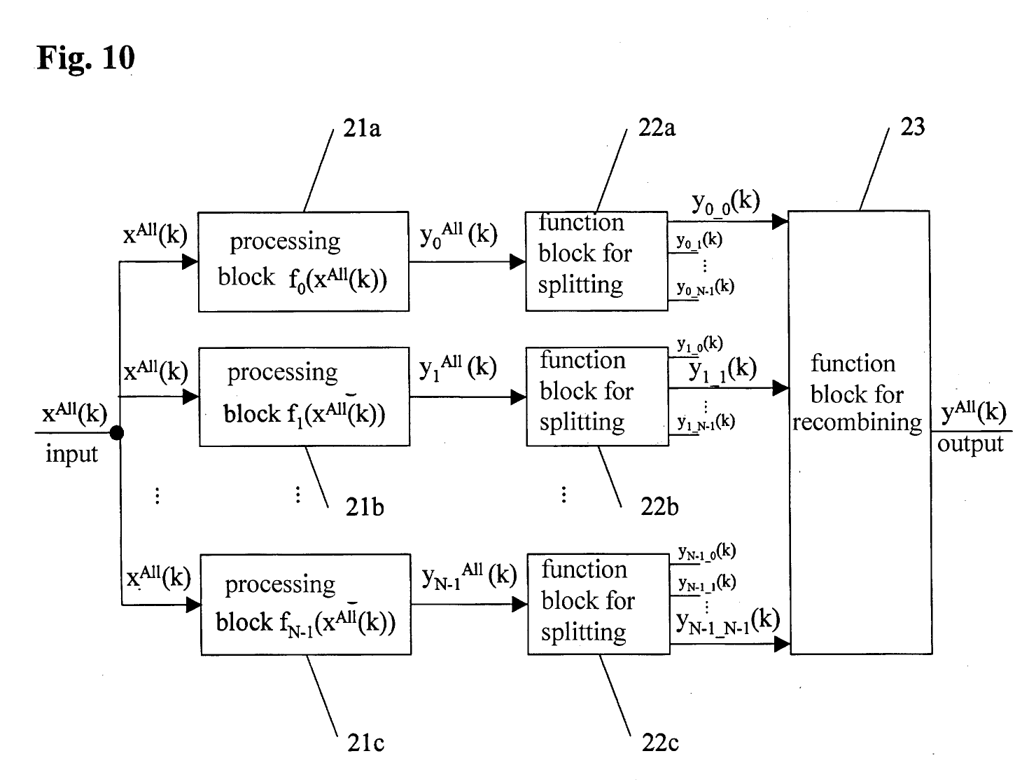

FIG. 10: a block diagram of a second embodiment form of the method according to the invention

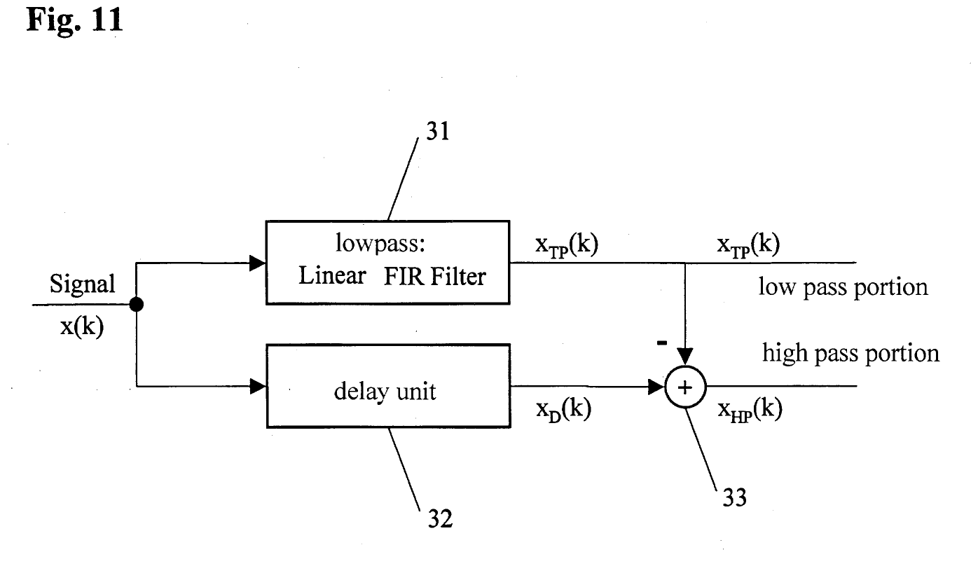

FIG. 11: a special form of a complementary filter bank for efficient splitting of a signal into two band through use of linear-phase FIR filters

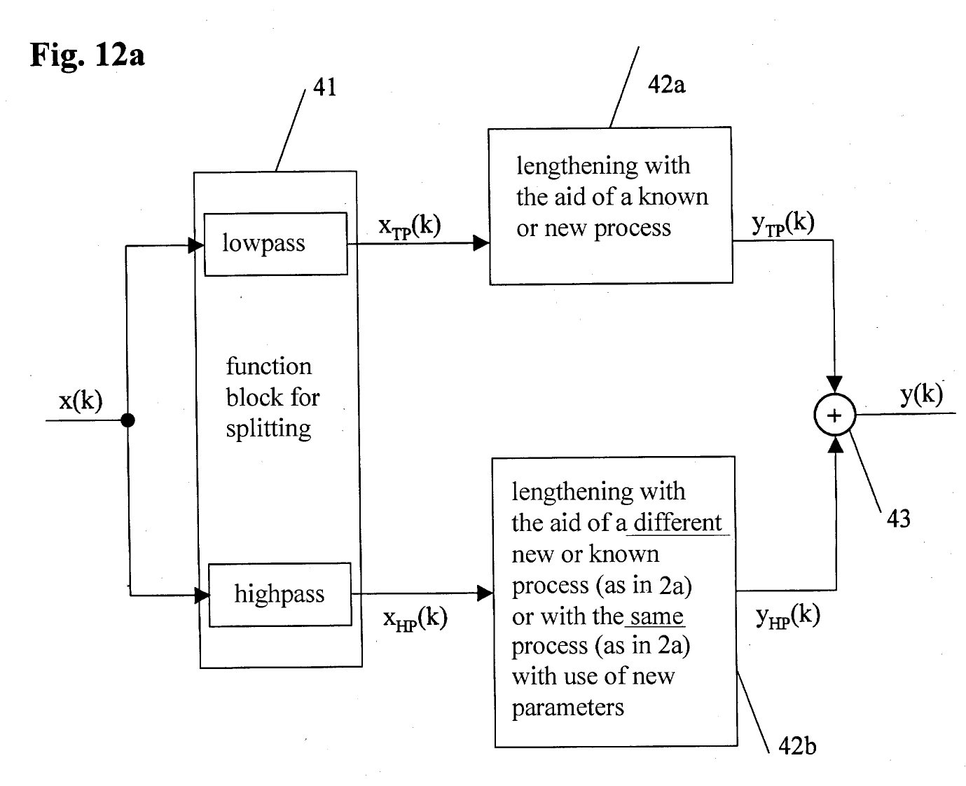

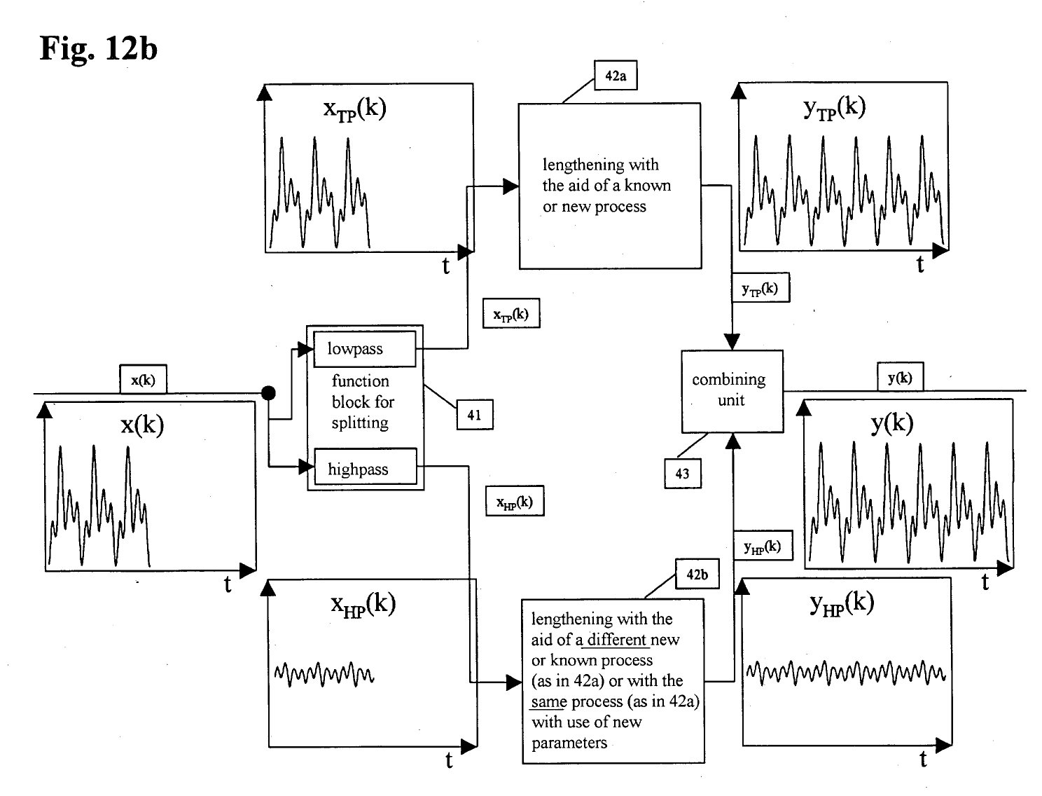

FIG. 12: a block diagram of a first embodiment form of the method according to the invention for changing the tone length

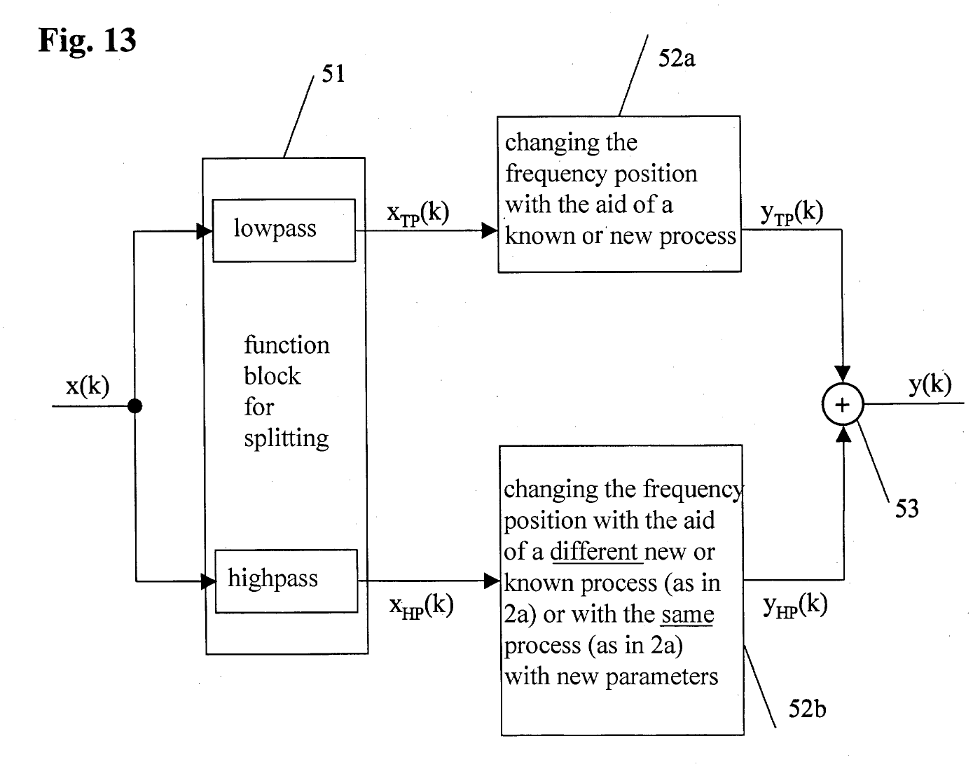

FIG. 13: a block diagram of a first embodiment form of the method according to the invention for changing the tone pitch

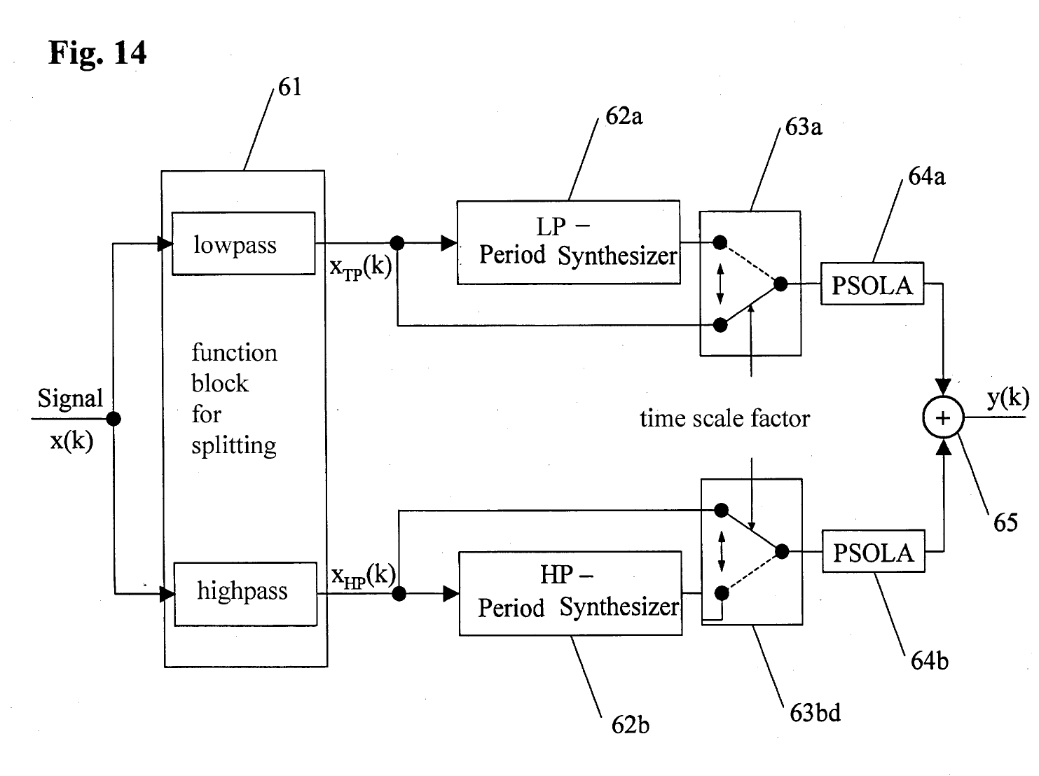

FIG. 14: a block diagram of a second embodiment form of the method according to the invention for changing the tone length

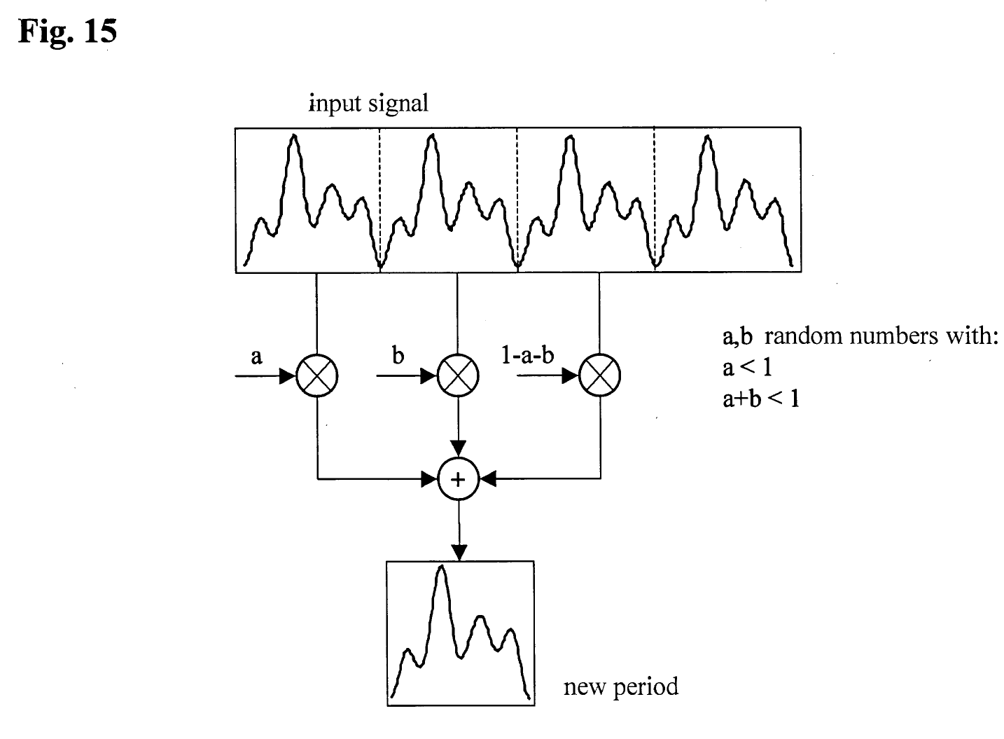

FIG. 15: a lowpass-period synthesizer

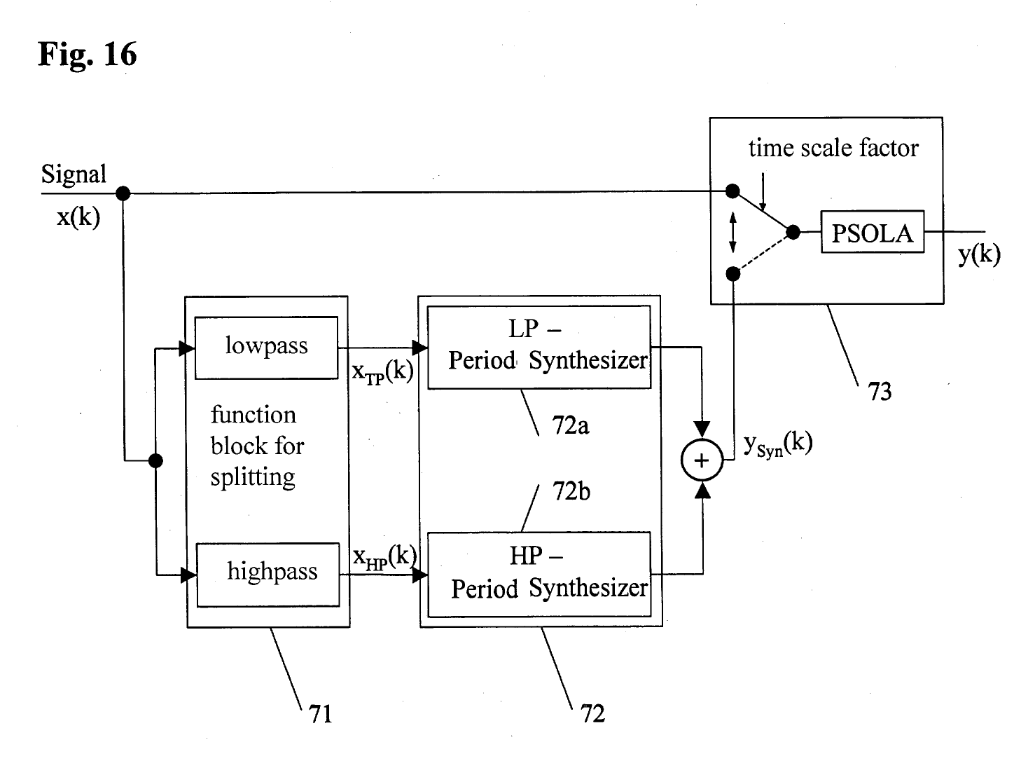

FIG. 16: a block diagram of a third embodiment form of the method according to the invention for changing the tone length

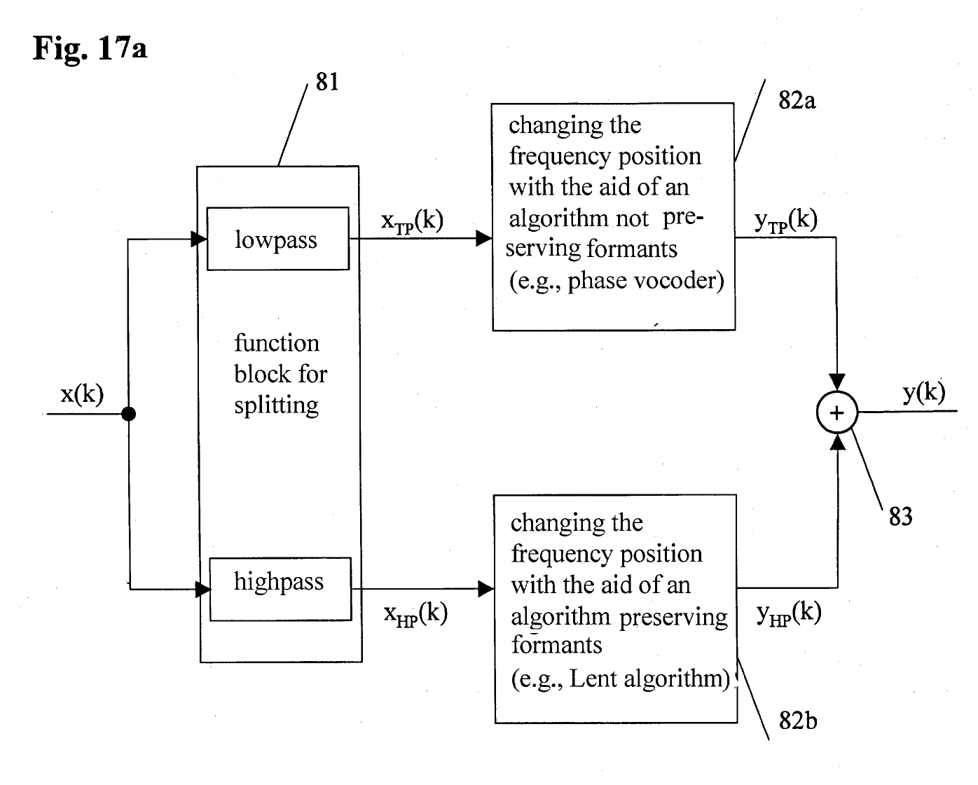

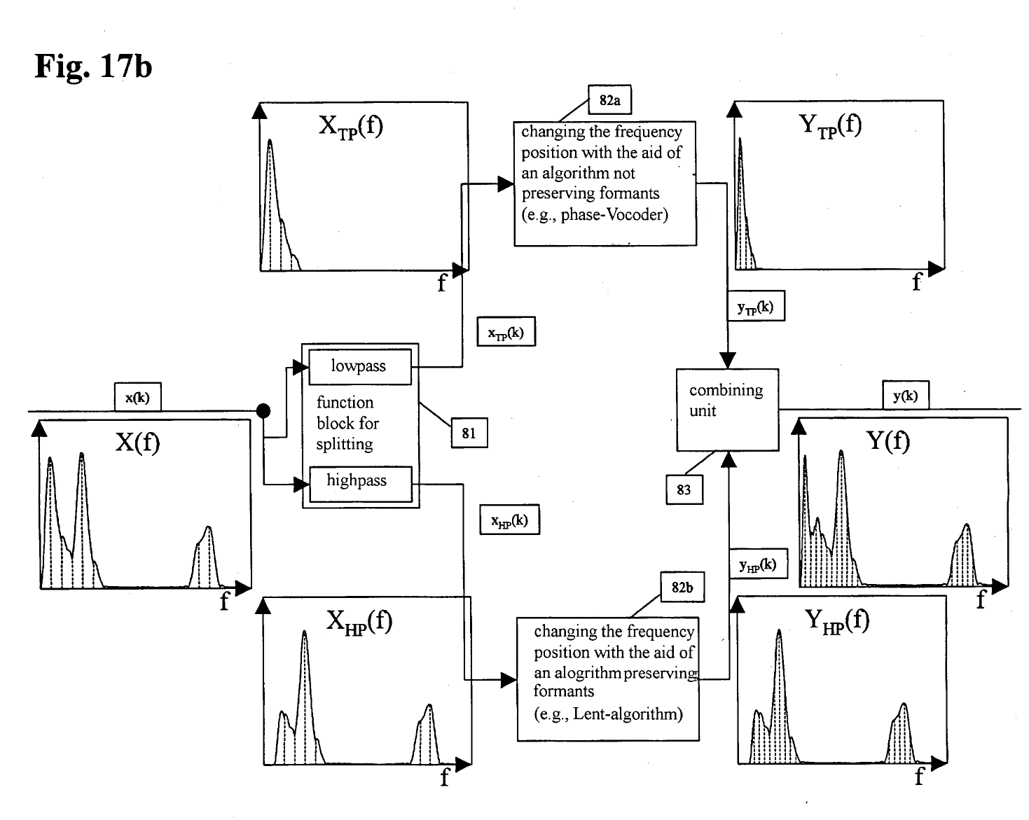

FIG. 17: a block diagram of a second embodiment form of the method according to the invention for changing the tone pitch

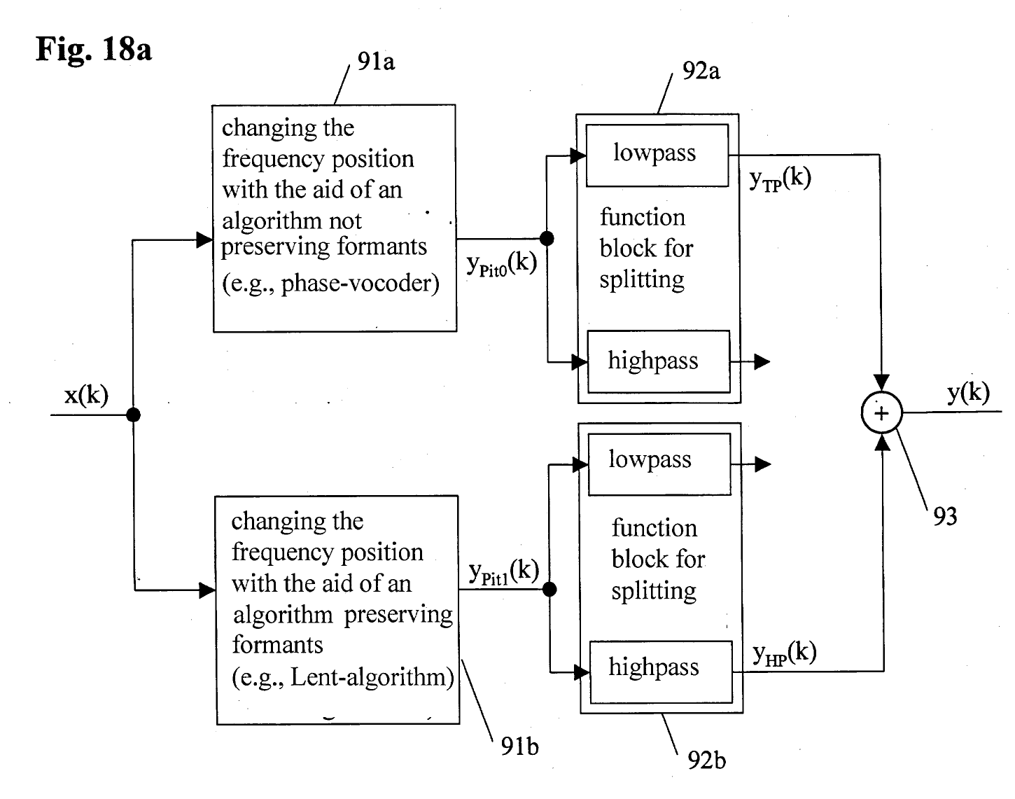

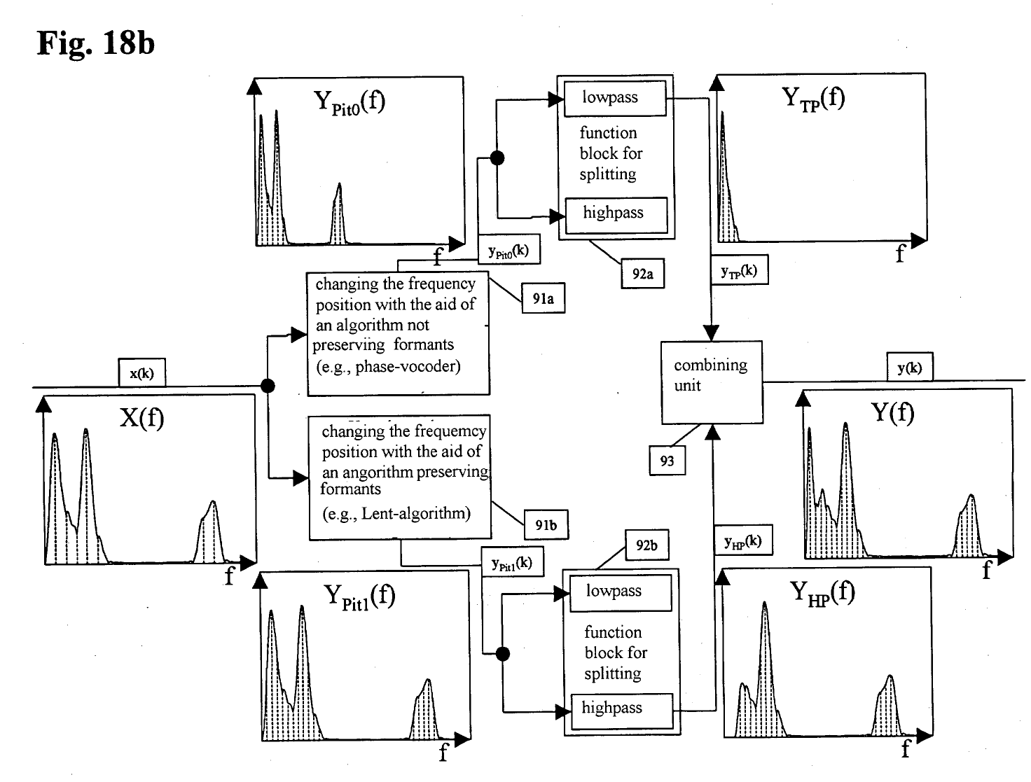

FIG. 18: a block diagram of a third embodiment form of the method according to the invention for changing the tone pitch

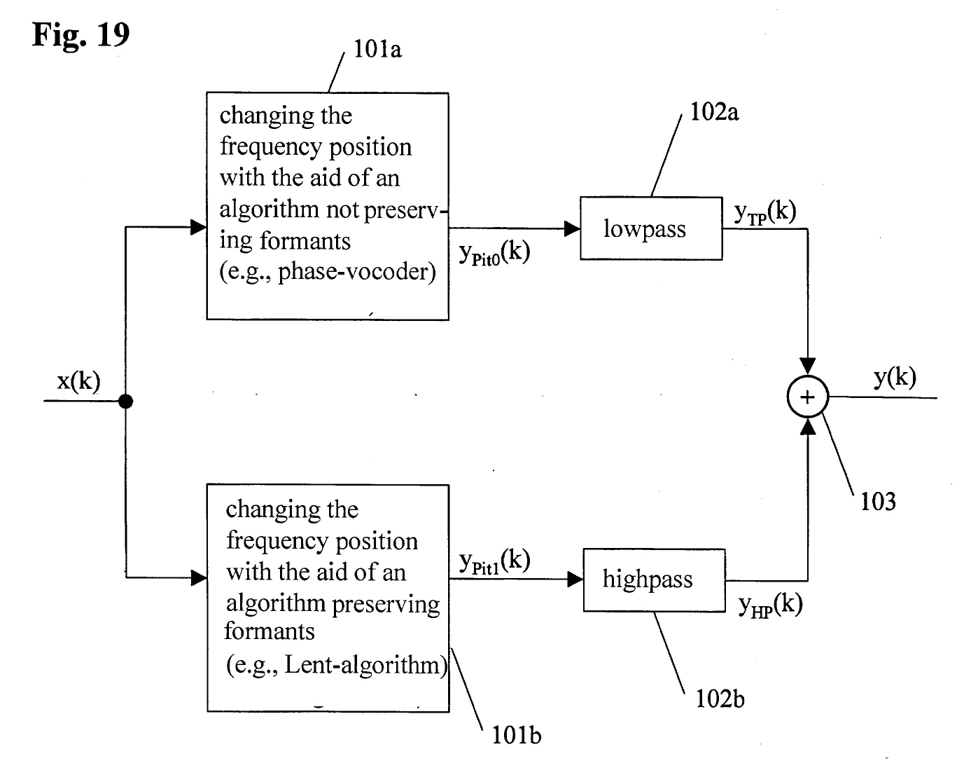

FIG. 19: a block diagram of a fourth embodiment form of the method according to the invention for changing the tone pitch

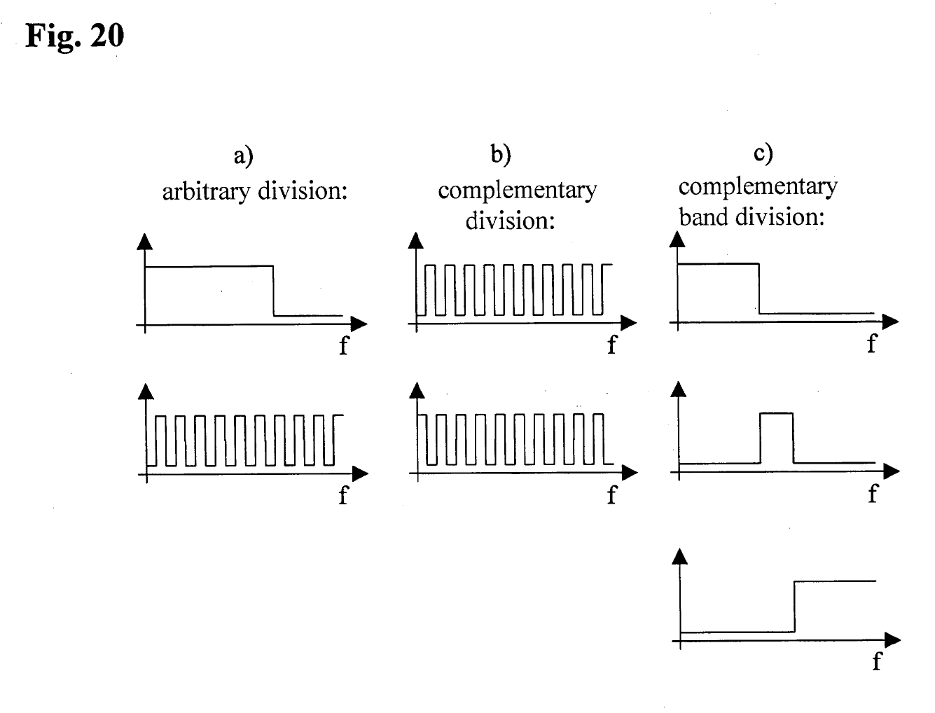

FIG. 20: different possibilities of the frequency splitting of audio signals

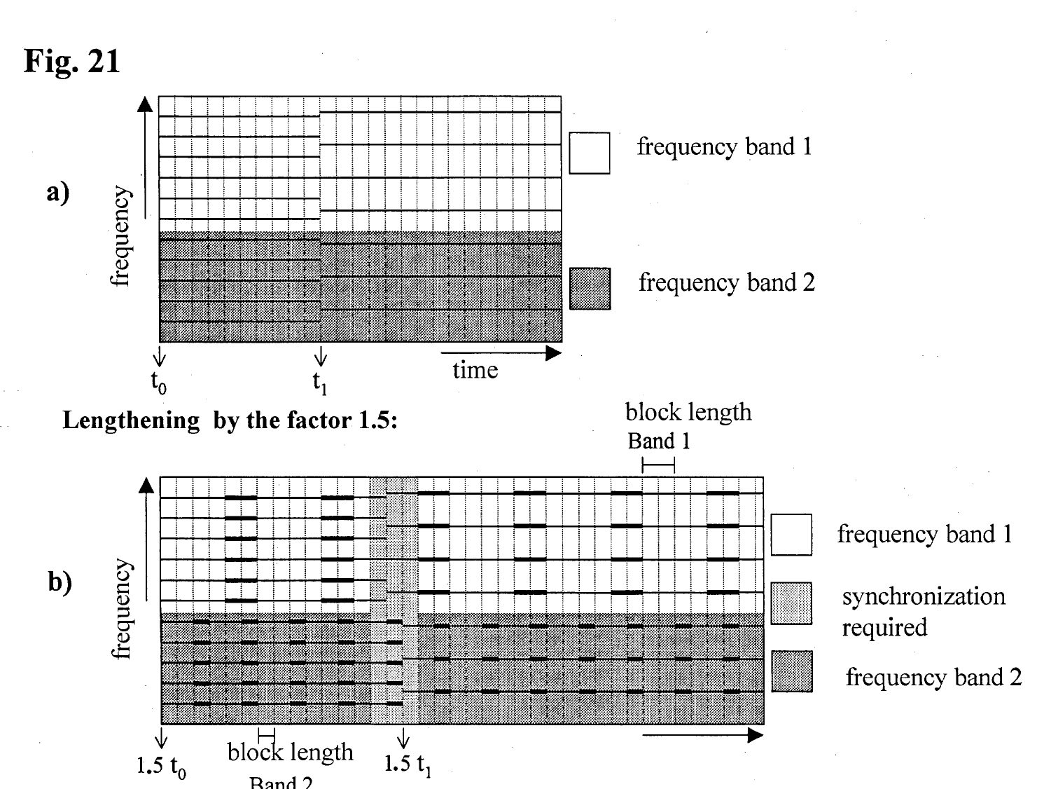

FIG. 21: schematically, the effect of the processing of a signal without synchronization of the processing channels

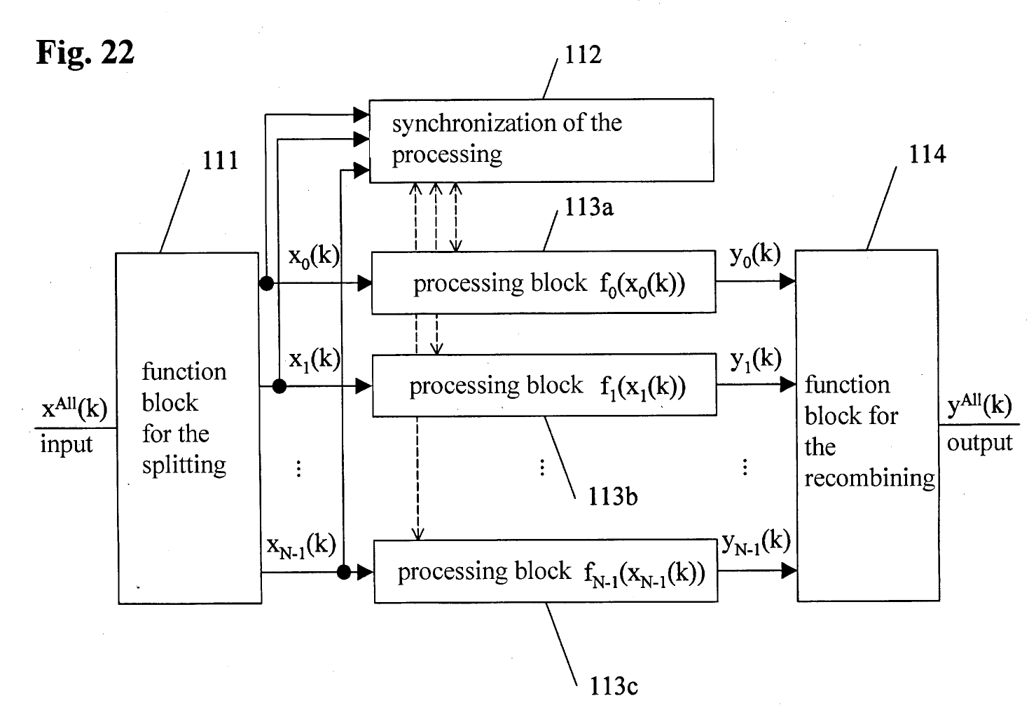

FIG. 22: a block diagram of a first embodiment form of the method according to the invention with synchronization

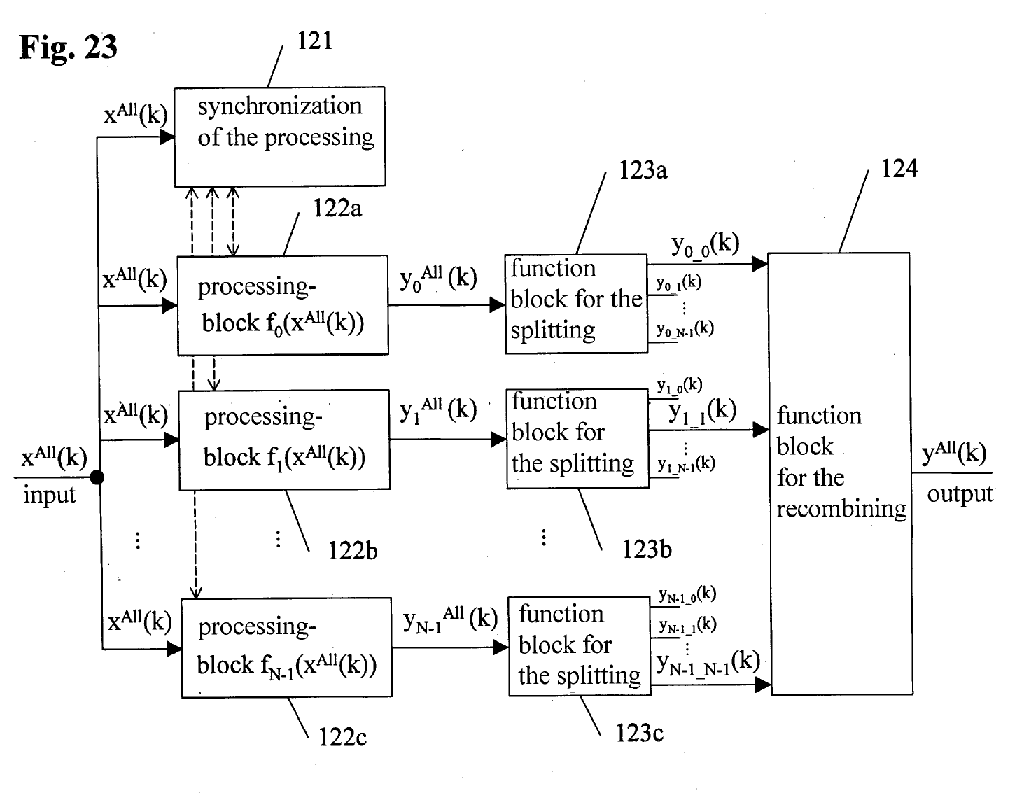

FIG. 23: a block diagram of a second embodiment form of the method according to the invention for changing the tone pitch

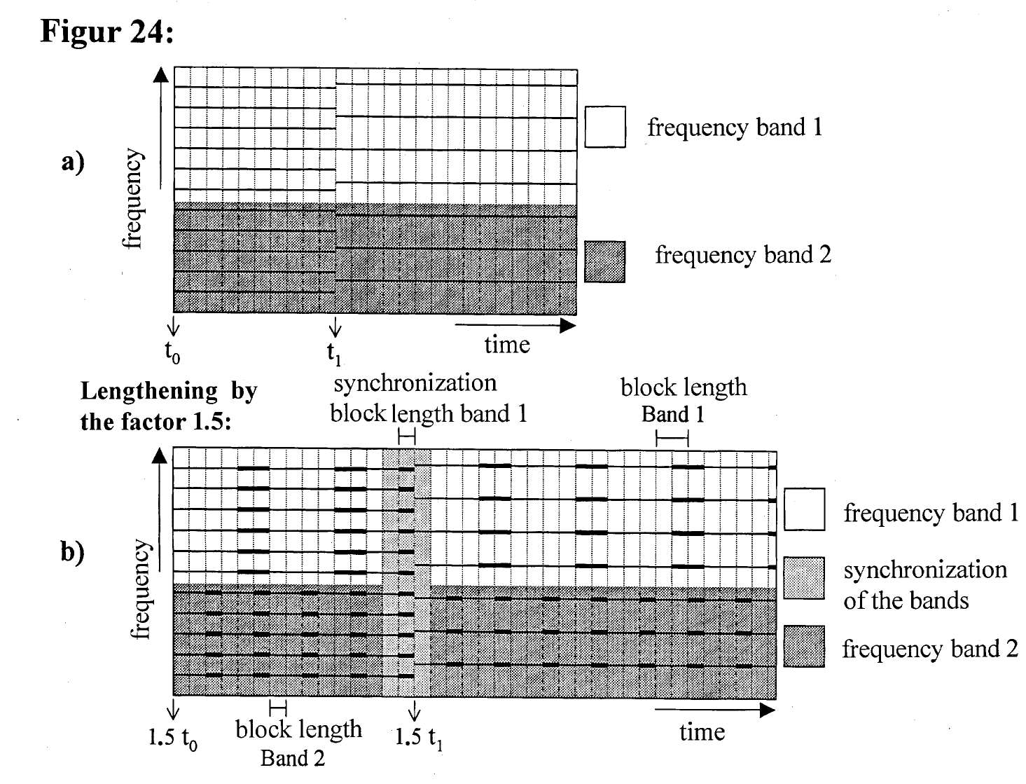

FIG. 24: schematically, the effect of the synchronization through adaptation of the block length

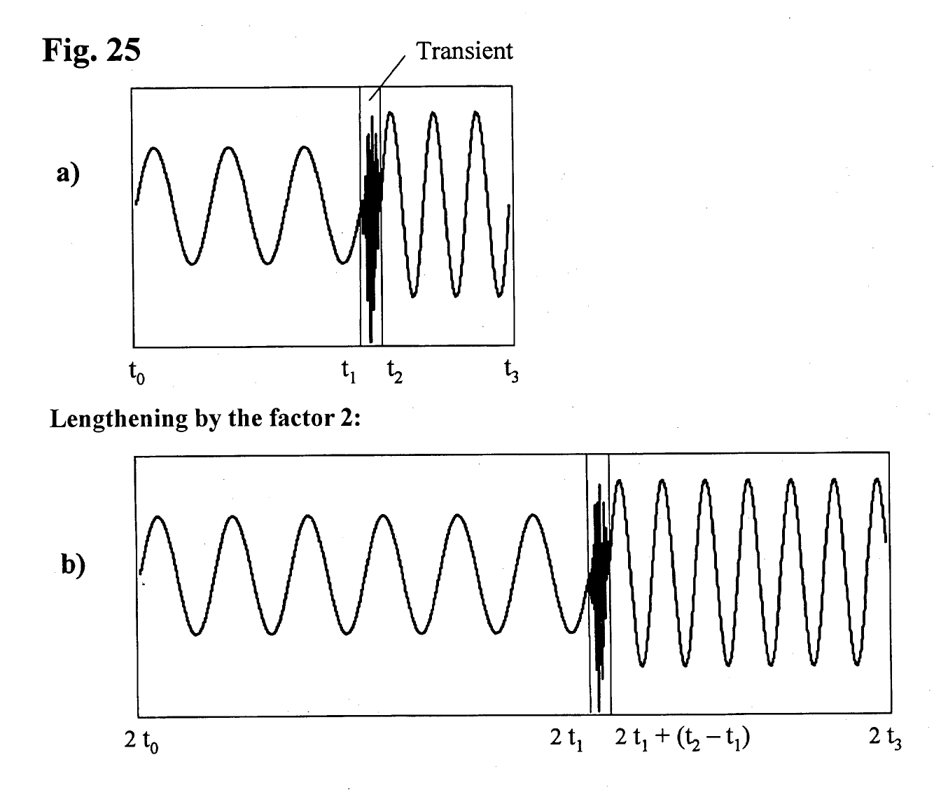

FIG. 25: schematically, the manner of operation of the preservation of transients during the synchronization

In order to explain the time-domain method for changing the tone length of audio signals mentioned in the introduction, the pitch synchronous splicing (PSS) and the pitch synchronous overlap-add (PSOLA) processes are shown in FIGS. 1 and 2. In the PSS time-domain process (FIG. 1) the changing of the signal length is based on a temporal repetition of short segments, a repetition in the raster of the fundamental frequency (pitch interval) being considered especially advantageous. FIG. 1a shows an original audio signal from which, for temporal lengthening, short segments are inserted after the original signal segments as repetitions, in order to achieve an extension of the temporal length of the audio signal by a factor of 2. FIG. 1b shows such a temporally extended audio signal.

For the PSOLA process shown in FIG. 2 a windowing by means of windowing functions (FIG. 2a) is additionally provided before the new signal segments are inserted into the output signal. The inserted signal segments are, in turn, windowed repetitions of the input signals at the interval of the fundamental frequency. In addition, a determination of the fundamental frequency is necessary, a large number of known algorithms being available for this purpose. FIG. 2b shows the audio signal having been temporally lengthened through insertion of the windowed repetition.

The manner of functioning of a phase vocoder for changing the tone length by means of a frequency-domain process is illustrated in FIG. 3. In this process the short-time spectra present in the frequency domain—shown in FIGS. 3a and 3b are frequency spectra at different scan time-points k—are mapped onto a new, fixed raster that corresponds to the factor of the temporal change. For example, in a doubling of the tone length, new, estimated spectra are inserted between the short-time absolute-value spectra. The calculation of the new spectra takes place by means of appropriate interpolation methods. Shown in FIGS. 3c and 3e are once again the spectra shown in FIGS. 3a and 3b, between which is inserted a new spectrum (FIG. 3d) interpolated from these spectra for a scan time-point between the scan time-points (k=1 and k=2) of the original spectra; resulting from this is a new scan-time ratster m=1, 2, 3.

With the phase vocoder, it has proved to be disadvantageous that, through the interpolation in the frequency domain, pulses in the time domain are clearly stretched and that for this reason pulse signals gain too much smoothness. For example, a pulse signal shown in FIG. 4a is transformed by this means into the stretched signal shown in FIG. 4b.

The resampling process for changing the tone pitch is illustrated in detail in FIG. 5. Here, the original signal to be modified (FIG. 5a) is lengthened (FIG. 5b) or shortened by a certain factor, in order to obtain a signal (FIG. 5c) having a changed tone pitch by means of a changed readout speed, i.e. the so-called resampling. For example, in the case of a tone pitch change of one octave (doubled frequency), a lengthening of the signal by a factor of two is necessary. If, now, only every second scan value is read out and the signal was previously lowpass filtered to avoid aliasing, then a signal with the doubled frequency is obtained. To illustrate the disadvantages of this method, in FIG. 6 the formant behavior during the resampling is made clear. In the application of the method to an original signal, whose spectrum is shown as an example in FIG. 6a, it turns out that the natural resonance behavior of an instrument, i.e. the formants, are likewise shifted. The new output signal (FIG. 6b) has an especially unnatural sound. In the case of speech, this is expressed by the so-called Mickey Mouse effect.

This problem is avoided by Lent's algorithm for changing the tone pitch, illustrated in FIG. 7. Here, in order to form the new output signal an overlapping of the partial segments in the raster of the desired new fundamental frequency (pitch interval) is carried out. FIG. 7a shows an original signal. FIG. 7b shows a new signal with lowered tone pitch, which signal is formed through the insertion of nulls between partial segments of the original signal, in the process of which the fundamental frequency is thus lowered. FIG. 7d shows a new signal with a higher tone pitch, which signal is formed through the overlapping of the periods of the original signal as shown in FIG. 7c, in the process of which the fundamental frequency is thus raised.

In this method, the formant behavior remains constant but the fundamental frequency can be changed as shown in FIG. 8. In FIG. 8a, a spectrum of an original signal (FIG. 7a) before the application of Lent's algorithm is shown; in FIG. 8b is shown a spectrum of a new signal with a lower tone pitch (FIG. 7b) after the application of Lent's algorithm. With natural signals, however, especially with a singing voice, the formants change slightly. For this reason the combination of Lent's algorithm with subsequent resampling, which effects only a very slight shifting, has proved to be especially favorable.

The method according to the invention is further elucidated with the aid of the block diagram of the device according to the invention shown in FIG. 9. The method is based on a splitting of the input signal X^{All}(k) by means of a separator 11. Thus, at the output of the separator 11 are present two or more partial signals, which in the following are designated x₀(k) for a first partial signal, x₁(k) for a second, and x_{N-1}(k) for an Nth. Each of these partial signals is fed to a separate processing channel with a separate processing unit 12a, 12b, 12c in each case, in which units the individual partial signals are processed in different ways. To describe the different types of processing, the general symbol f(x₀(k)) is introduced; thus, the different types of processing are designated f₀(x₀(k)), f₁(x₁(k)), and f_{N-1}(x_{N-1}(k)). The differences in the processing can be achieved here through the selection of different parameters of a particular method that is applied in all of the processing units 12a, 12b, 12c, or through different methods. In a concluding combining unit 13 the differently processed partial signals y₀(k), y₁(k), . . . , y_{N-1}(k) are again combined into an output signal y^{All}(k).

A further possibility for realizing the method according to the invention is presented by the device shown in block-diagram form in FIG. 10. Here, the input x^{All}(k) is copied without modification and fed to the individual processing channels with the different processing units 21a, 21b, 21c, which are designated f₀(x^{All}(k)), f₁(x^{All}(k)), and f_{N-1}(x^{All}(k)). A subsequent splitting by means of a separator 22a, 22b, 22c in each processing channel causes a splitting of the output signals yᵢ^{All}(k) (i=0, 1, . . . , N−1) into N different partial signals y_{i—i}(k) in each case. In the concluding combining unit 23, in each case one partial signal is selected from each processing channel and combined into the output signal y^{All}(k). In the example shown, the partial signals y_{0—0}(k), y_{1—1}(k), . . . , y_{N-1—N-1}(k) are combined into the output signal y^{All}(k).

Preferably, in the method according to the invention, a splitting of the input signal into different frequency ranges takes place in the separator 11a or the separators 22a, 22b, 22c by means of appropriate filters. For example, a splitting into two frequency bands takes place through a highpass filter and a lowpass filter.

Especially advantageous in this connection is the use of linear-phase FIR filters, since by means of these an especially efficient decomposition can occur, as is illustrated in detail in FIG. 11. The input signal x(k) is filtered by a lowpass filter 31, which results in the output signal x_{TP}(k). The linear-phase lowpass filter 31 with an odd number of coefficients possesses a constant group propagation time, which can and must be compensated through a simple delay unit. For this reason, the input signal x(k) is also delayed by this length of time by means of a delay unit 32. In the concluding process step, from this delayed signal x_{D}(k) the lowpass output signal x_{TP}(k) is derived by means of an adder

33, which results in the complementary highpass portion x_{HP}(k) of the signal.

A further form of a device according to the invention for changing the tone length (time scaling) is shown in FIGS. 12a and 12b. FIG. 12a shows a simplified block diagram of the device, while FIG. 12b shows examples of the signals formed. The input signal x(k) is decomposed in the separator 41, by means of a lowpass filter 41a and a highpass filter 41b, into lowpass and highpass components x_{TP}(k) and x_{HP}(k), respectively. By aid of a method known in the art or a new method, the lowpass signal x_{TP}(k) is temporally modified in the processing unit 42a, resulting in an output signal y_{TP}(k). The high pass component x_{HP}(k) is modified through another process known in the art or another new process, or through the same process but with use of a different parameter, in the processing unit 42b, the manner of the modification being the same for both components, e.g. a temporal lengthening by 100%. The result is an output signal y_{HP}(k). A summing at the combination unit 43 leads to the desired output signal y(k), which is characterized through an improved sound in comparison to the application of the individual algorithms.

The realization of a method according to the invention for changing the tone pitch (pitch shift) is shown in FIG. 13. In the separator 51 the input signal x(k) is decomposed, in order to then be modified in different ways by means of the processing units 52a, 52b. Subsequently, the complete output signal y(k) is generated with the aid of a summation as combination unit 53.

A special realization of the method according to the invention for changing the tone length (time scaling) is shown in FIG. 14. In the separator 61 the input signal x(k) is decomposed into a lowpass and a highpass component x_{TP}(k) and x_{HP}(k), respectively. From the lowpass component x_{TP}(k) a new lowpass partial signal is generated through an appropriate combination of several sections by means of a lowpass-period synthesizer 62a. In the first embodiment, the appropriate combination consists of a superimposition of three weighted periods, the weighting being determined here through two random magnitudes a, b, as shown in FIG. 15, which illustrates the manner of functioning of the lowpass-period synthesizer 62a.

Likewise, from the highpass component x_{HP}(k) a new highpass partial signal is generated through an appropriate method by means of a highpass-period synthesizer 62b, e.g. through the random selection of a neighboring period, in other words, through a method different from that applied in the lowpass-period synthesizer 62a. Through the random selection can arise no unambiguous correlation, which is to be avoided.

The new, synthesized partial signals are generated in dependence on the selected factors of the changing and inserted into the lowpass or highpass signal, x_{TP}(k) or x_{HP}(k), respectively, with time-controlled switches 63a, 63b being provided for switching between the lowpass or highpass signal and the new lowpass or highpass partial signal. The introduction itself occurs through the above-described PSOLA process in PSOLA units 64a, 64b. The subsequent summing in the combination unit 65 leads to the output signal y(k), which possesses a distinctly greater degree of naturalness.

An equivalent implementation with the particular advantage of a lower computational performance is possible when the common portions of the calculation are carried out in the broadband input signal. It is possible to carry out the insertion of the periods generated by synthesis in the original signal and to carry out only the generation of the synthesized periods in the split signal. A block diagram of a corresponding device is shown in FIG. 16. This device displays a separator 71, a synthesizer 72 with a lowpass-period synthesizer 72a and a highpass-period synthesizer 72b, an adder 73, and a controlled switching and inserting unit 74. The resulting output signal y(k) is equivalent to the signal y(k) from FIG. 14 when the same parameters are used for the individual elements of the device and complementary filter banks, as shown in FIG. 11, are used.

A special implementation of the method according to the invention for changing the tone pitch is shown in FIG. 17. FIG. 17a shows a block diagram of a corresponding device; FIG. 17b shows the spectra of the occurring signals. The input signal is decomposed in the separator 81. The lowpass signal x_{TP}(k) is lengthened through a known application, e.g. PSOLA or phase vocoder, in the processing unit 82a and, through resampling, shifted to the desired tone pitch. Thus, the previously mentioned artifacts of the formant shifting appear only for these frequency regions. The highpass component x_{HP}(k), in contrast, is shifted to the desired tone pitch in the processing unit 82b by means of Lent's algorithm or another formant-preserving algorithm. The summing of the signals in the combination unit 83 leads to the output signal y(k), which is distinguished through a higher degree of naturalness, especially in the case of a downward shifting of the tone pitch.

A similar result can also be achieved when the sequence of the processing is reversed, as in the method illustrated in FIG. 18. FIG. 18a shows a block diagram of a corresponding device; FIG. 18b shows the spectra of the occurring signals. In this manner it is possible, first, to transform the input signal x(k) to the desired, new pitch height through a lengthening and resampling by means of a first processing unit 91a, and second, to carry out a processing with a formant-preserving algorithm (e.g. Lent's algorithm) by means of a second processing unit 91b. The first signal y_{TP}(k) is subsequently decomposed with the aid of a first separator 92a. Likewise, the second signal y_{Pit1}(k) is decomposed with the aid of a second separator 92b. Finally, different partial signals, in this example the lowpass signal y_{TP}(k) of the first separator 92a and the highpass signals y_{HP}(k) of the second separator 92b, are recombined in the combination unit 93.

A reduced calculation-time form, which is nevertheless equivalent in terms of the output signal, is shown in FIG. 19. Here, the output signals of the processing units 101a, 101b having algorithms for changing the tone pitch y_{Pit0}(k) and y_{Pit1}(k), are fed to a lowpass filter 102a and a highpass filter 102b, respectively. A final summing of the filtered signals in the combination unit 103 results in the output signal y(k), which possesses a distinctly improved naturalness.

Especially in the case in which different algorithms are used, it can happen that a simple summing of the differently processed partial signals does not work, since the different algorithms require, in part, different block sizes, and consequently a temporal mismatch arises. A further problem results from the fact that some methods are pitch-synchronous (PSOLA, Lent), but others (resampling, phase vocoder) are not. Thus, both phase differences and different partial-signal lengths can occur, which differences should be equalized. In order to nevertheless obtain an appropriate output signal, a synchronization unit is preferably provided in the combination unit, which synchronization unit delays the differently-processed signals with respect to their propagation time, length, and phase, and properly combines them.

FIG. 20 shows the different possibilities of frequency splitting by means of the separators, which frequency splitting is preferably used in the invention. The simplest form of the frequency splitting, as shown in FIG. 20a, is an arbitrary assignment of the frequencies to a partial signal, in which case a frequency may also be assigned more than once. The individual partial signals, the spectra of which are shown in FIG. 20a for two partial signals, can thus be obtained via filters with an appropriate conversion function.

A second possibility of the frequency splitting, as shown in FIG. 20b, is the complementary splitting. In this type of splitting, the frequency range is divided into several non-overlapping partial regions. Important here is the fact that each frequency is assigned to only one partial signal in each case, and thus the individual frequency regions are not assigned more than once. The generation of the partial signals, the spectra of which are again shown in FIG. 20b for two partial signals, can take place via complementary filters.

A third, and in the context of the present invention preferred, form of the frequency splitting is the complementary band splitting, as shown in FIG. 20c. Here, the frequency range is divided by lowpass, bandpass, and highpass filters such that each frequency region is coherent and is assigned to only one partial signal. The spectra of three such partial signals are shown in FIG. 20c.

A further preferred frequency splitting consists in the temporal modification of the frequency bands, that is to say, the frequency splitting is adjusted during the processing of the signal. A possible adjustment of the frequency splitting consists in controlling the bandwidth of the partial signals via the fundamental frequency (pitch) of the audio signal.

Represented in FIG. 21 is the manner of action of the first two methods according to the invention in the frequency domain. Here, the original signal (FIG. 21a) is first of all split into two frequency bands (partial signals). The original signal consists here of a sequence of two tones, the tone changeover taking place at time point t₁. The two frequency bands are lengthened by a factor of 1.5 separately from each other using different methods (FIG. 21b). As can be seen in FIG. 21b, due to the different block lengths that were used for the lengthening of the partial signals by different methods, there occurs an overlapping at time point 1.5 t₁ of the two tones that were present in the original signal. Thus, it has proved to be advantageous to avoid such an overlapping through a synchronization of the processing methods at prominent places in the signal.

An especially preferred embodiment form of the method according to the invention shall be explained in detail with the aid of the block diagram, shown in FIG. 22, of the device according to the invention. The method is based, as is the first method according to the invention, on a splitting of the input signal x_{All}(k) by means of a separator 111. At the output of the separator 111 are thus present two or more partial signals, which in the following are designated x₀(k) for a first partial signal, x,(k) for a second, and xₙ₋₁(k) for an Nth. Each of these partial signals is fed to a separate processing channel with a separate processing unit 113a, 113b, 113c in each case, in which Units the individual partial signals are processed in different ways. To describe the different types of processing, the symbol f(x₀(k)) is again used; thus, the different types of processing are designated f₀(x₀(k)), f₁(x₁(k)), and f_{N-1}(x_{N-1}(k)). The difference in the processing can be achieved here through the selection of different parameters of a particular method that is applied in all of the processing units 113a, 113b, 113c, or through different methods. In addition, the partial signals x₀(k), x₁(k) through x_{N-1}(k) are fed to a synchronization unit 112. Through this synchronization unit 112, the processing of the individual partial signals is monitored, and through appropriate control signals a synchronization of the processing channels at certain time points in the signal is achieved. . In a concluding combination unit 114 the differently processed partial signals y₀(k), y₁(k), . . . , y_{N-1}(k) are again combined into an output signal y₀(k).

A further possibility for realizing the method according to the invention is presented by the device shown in block-diagram form in FIG. 23. Here, the input x^{All}(k) is copied without modification and fed to the individual processing channels with the different processing units 122a, 122b, 122c, which are designated f₀(x^{All}(k)), f₁(x^{All}(k)), and f_{N-1}(x^{All}(k)), and fed to the synchronization unit 121. Through the synchronization unit 121 is achieved again a synchronization of the processing channels at certain time points in the signal by means of control signals. A subsequent splitting by means of a separator 123a, 123b, 123c in each processing channel causes a splitting of the output signals yᵢ^{All}(k) (i=0, 1, . . . , N−1) into N different partial signals y_{i—i}(k) in each case. In the concluding combining unit 124, in each case one partial signal is selected from each processing channel and combined into the output signal y^{All}(k). In the example shown, the partial signals y_{0—0}(k), y_{1—1}(k), . . . , y_{N-1—N-1}(k) are combined into the output signal y^{All}(k).

Shown schematically in FIG. 24 is the effect of a lengthening by a factor of 1.5 with synchronization. In this case, in order to preserve the represented tone changeover at time point 1.5 t₁, the block length of the first band is rapidly adjusted such that the tone changeover can occur without problem.

Especially advantageous here is a synchronization of the signal at transients. In this context, transients signify transitional sounds, thus places at which the signal changes rapidly.

A special realization form of the method according to the invention is illustrated in FIG. 25. Represented in FIG. 25a is an original signal in the time domain, with a transient present in the signal at time point t₁, which transient lasts until time point t₂. Shown in FIG. 25b is a signal lengthened by a factor of 2. Here the processing channels were synchronized such that the original-signal segment t₀ to t₁ is reproduced on the lengthened signal segment 2 t₀ to 2 t₁. Now, over the duration of the transient no lengthening at all was carried out, in order to preserve the original transitional sounds. After that, the next signal segment was lengthened such that the signal as a whole possesses a precisely doubled length compared to the original signal.

1. Method for changing the temporal length and/or the tone pitch of a discrete audio signal comprising the following steps:
splitting of the audio signal into at least two partial signals
feeding of the partial signals to a processing channel in each case
separate changing of the temporal length and/or the tone pitch of the partial signals in different ways
combining of the separately processed partial signals to form an output signal

2. Method for changing the temporal length and/or the tone pitch of a discrete audio signal comprising the following steps:
feeding of the audio signal to at least two parallel processing channels
separate changing of the temporal length and/or the tone pitch of the partial signals in the processing channels in different ways
splitting of the separately processed audio signals into at least two partial signals in each case
forming of an output signal through combination of at least one partial signal of each processing channel in each case.

3. Method according to claim 1 or 2, characterized in that the separate processing in the at least two parallel processing channels takes place by means of the same method with different parameters or by means of different methods.

4. Method according to claim 1, characterized in that the changing of the tone length of at least one of the partial signals takes place in a processing channel through insertion of newly calculated signal components, the newly calculated signal components being determined by means of a weighted summing of at least two, especially three, adjacent signal components of the partial signal, or by means of a random selection of adjacent signal components of the partial signals.

5. Process according to claim 1, characterized in that for changing the tone length of the audio signal for at least one of the partial signals in a processing channel, newly calculated signal components are determined by means of a weighted summing of at least two, especially three, adjacent signal components of the partial signal or by means of a random selection of a partial signal from adjacent signal components, that the partial signals are then combined into an output signal having new signal components, and that the changing of the tone length of the audio signal takes place through the insertion of signal components of this output signal into the audio signal.

6. Method according to claim 4 or 5, characterized in that derived signal components of a partial signal in the interval of the fundamental frequency are used for calculation of the new signal components.

7. Method according to one of the claims 4 through 6, characterized in that the insertion of the newly calculated signal components takes place according to the PSOLA process.

8. Method according to one of the claims 4 through 7, characterized in that the new signal components of at least one partial signal are determined through a random selection from adjacent components of the partial signal.

9. Method according to claim 2, characterized in that for changing the tone length of the audio signal in at least one processing channel, newly calculated signal components are determined by means of a weighted summing of at least two, especially three, adjacent signal components of the audio signal or by means of a random selection of a partial signal from adjacent signal components, that the audio signals thus processed are split into at least two partial signals in each case, that an output signal having new signal components is formed through combination of at least one partial signal of each processing channel in each case, and that the changing of the tone length of the audio signal takes place through the insertion of signal components of this output signal into the audio signal.

10. Method according to claim 1 or 2, characterized in that for changing the tone pitch of the audio signal in at least one processing channel, a formant-preserving algorithm is used for changing the tone pitch of the signal in at least this one processing channel, and that in at least one other processing channel a formant-changing algorithm is used for changing the tone pitch of the signal in at least this one processing channel.

11. Method according to claim 1 or 2, characterized in that the splitting into partial signals takes place through frequency splitting.

12. Method according to claim 11, characterized in that the frequency splitting takes place through filtering by means of at least one linear-phase and/or purely transversal filter.

13. Method according to claim 11 or 12, characterized in that the frequency splitting into only two frequency bands takes place by means of a single filter, the complementary component of the filtered signal being formed through subtraction of the filtered signal from a delayed version of the unfiltered signal.

14. Method according to claim 11 or 12, characterized in that in the frequency splitting a complementary splitting of the frequency components takes place such that the frequency range is divided into several non-overlapping frequency regions, in particular such that the frequency range is divided through filtering in the frequency domain into several, in each case coherent frequency regions, which are in each case assigned to only one partial signal.

15. Method according to claim 11, characterized in that the frequency splitting takes place in a time-varying manner.

16. Method according to claim 15, characterized in that the time-varying frequency splitting is controlled through the fundamental frequency of the audio signal.

17. Method according to claim 1 or 2, characterized in that the partial signals are delayed, in particular by means of delay elements, prior to the formation of the output signal through combination.

18. Method according to claim 1 or 2, characterized in that the changing of the temporal length and/or the tone pitch of the discrete audio signal takes place at a constant scan rate.

19. Method according to claim 1 or 2, characterized in that the separate processing of the at least two partial signals or of the audio signal, as the case may be, in the at least two processing channels is synchronized at least at times.

20. Method according to claim 19, characterized in that control signals, in particular of the processing channels, are handled in a synchronization unit for synchronization of the separate processing.

21. Method according to claim 19, characterized in that the synchronization of the separate processing occurs at transients in the audio signal.

22. Method according to claim 21, characterized in that the synchronization occurs in such a way that the transients are not modified.

23. Device for changing the temporal length and/or the tone pitch of a discrete audio signal comprising:
a separator for splitting the audio signal into at least two partial signals
at least two parallel processing channels, to which, in each case, a partial signal is fed
a processing unit in each processing channel for separate changing of the temporal length and/or the tone pitch of the partial signals in different ways
a combination unit for combining the separately-processed partial signals into an output signal.

24. Device for changing the temporal length and/or the tone pitch of a discrete audio signal comprising:
at least two parallel processing channels, to which, in each case, the audio signal is fed
a processing unit in each processing channel for separate changing of the temporal length and/or the tone pitch of the audio signals in the processing channels in different ways
a separator for splitting the separately-processed audio signals into at least two partial signals in each case
a combination unit for formation of an output signal through combination of, in each case, at least one partial signal of each processing channel.

25. Computer program with computer-program means for causing a computer to implement the method steps of the method according to claim 1 or 2 when the computer program is executed on a computer.

26. Computer-readable data carrier on which the computer program according to claim 15 is stored.
